(19) United States
(12) Patent Application Publication
(10) Pub. No.: US 2025/0118870 A1
(43) Pub. Date: Apr. 10, 2025

(54) BATTERY INTERCONNECT SYSTEM

(71) Applicant: Hexagon Purus North America Holdings Inc., Lincoln, NE (US)

(72) Inventors: Landon Tyerman, Kelowna (CA); Sridutta Aditya Akula, West Kelowna (CA); Andrew Michalak, Kelowna (CA); Eric M. Coupal-Sikes, Kelowna (CA)

(21) Appl. No.: 18/982,442

(22) Filed: Dec. 16, 2024

Related U.S. Application Data
(63) Continuation of application No. PCT/US2023/026954, filed on Jul. 5, 2023.
(60) Provisional application No. 63/639,427, filed on Apr. 26, 2024.

(51) Int. Cl. H01M 50/507; B60L 50/64; H01M 50/204; H01M 50/258; H01M 50/509

(52) U.S. Cl. CPC H01M 50/507; B60L 50/64; H01M 50/204; H01M 50/258; H01M 50/509; H01M 2220/20

(57) ABSTRACT

In one embodiment a battery module having a width and a length includes a plurality of battery cells and a plurality of bus bars. The plurality of battery cells can be arranged in a plurality of physical rows along the length of the battery module. The plurality of bus bars can be located along the length of the battery module and define a plurality of electrical rows. Each bus bar can be electrically coupled to battery cells of more than one physical row. The battery cells of each electrical row can be connected in parallel and the electrical rows can be connected in series.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 C.F.R. § 1.57.

### BACKGROUND

### Field of the Invention

This application is directed to bus bars that facilitate electrical connection of battery cells in a battery module.

### Description of the Related Art

Typical battery modules use bus bars that connect a number of battery cells within the module. In larger assemblies of batteries more than one module may be provided. This can result in complexities in connecting the battery modules together within a larger battery assembly.

### SUMMARY

There is a need for an improved bus bar, e.g., one that allows battery cells in more than one longitudinally aligned row to be coupled to a single bus bar. Also, there is a need for enhanced flexibility in a manner of connecting more than one battery module in a larger battery assembly.

In one embodiment, a battery module has a width and a length. The battery module comprises a plurality of battery cells and a plurality of bus bars. The plurality of battery cells are arranged in a plurality of physical rows along the length of the battery module. The plurality of bus bars are located along the length of the battery module and defining a plurality of electrical rows of battery cells. Each bus bar is electrically coupled to battery cells of more than one of the physical rows. The battery cells of each electrical row are connected in parallel and the electrical rows are connected in series.

In some embodiments, at least one of the battery cells of each physical row is not connected in parallel with an adjacent battery cell in the physical row. In some embodiments each bus bar is electrically coupled to battery cells in three physical rows. In some embodiments, each bus bar of the plurality of bus bars connects a number of battery cells that exceeds the number of battery cells in one of the physical rows. In some embodiments, the battery cells in a first physical row are positioned offset the battery cells in a second physical row adjacent to the first physical row. In some embodiments, the battery modules further comprise a top plate positioned on top of the plurality of battery cells, the top plate comprising a plurality of openings configured to expose a positive terminal and a negative terminal of each battery cell.

In one embodiment, a battery assembly comprises a housing and a battery module enclosed by the housing. The battery module comprises a plurality of battery cells and a plurality of bus bars. The plurality of battery cells are positioned in a plurality of physical rows. Each bus bar of the plurality of bus bars is coupled to a subset of battery cells of the plurality of battery cells disposed in more than one physical row. The bus bar and the subset of batteries coupled thereto forming electrical rows of the battery. The battery cells of each electrical row are connected in parallel and the electrical rows are connected in series.

In some embodiments, the battery module is a first battery module. The battery assembly further comprising a second battery module. The first battery module and the second battery module configured to have opposite polarities. In some embodiments, the battery assembly is coupled to a vehicle. In some embodiments, at least one of the battery cells of each physical row is not connected in parallel with an adjacent battery cell of the physical row. In some embodiments, each bus bar is electrically coupled to battery cells in three physical rows. In some embodiments, the battery assembly further comprises a top plate positioned on top of the plurality of battery cells, the top plate comprising a plurality of openings configured to expose a positive and a negative terminal of each battery cell of the plurality of battery cells.

In one embodiment, a battery module comprises a plurality of battery cells and a plurality of bus bars. The plurality of battery cells are arranged in a plurality of linear rows. A first end of each of the plurality of battery cells is coupled to a bottom plate. The plurality of bus bars are coupled to a top plate. The top plate is positioned above a second end of each of the plurality of battery cells. The top plate comprises a plurality of openings configured to expose a positive terminal and a negative terminal of each battery cell. At least one bus bar of the plurality of bus bars has a non-linear shape whereby a first portion of the at least one bus bar is coupled with one or more battery cells in a select linear row of the plurality of linear rows and a second portion of the at least one bus bar is coupled with one or more cells not in the select linear row of the plurality of linear rows.

In some embodiments, the battery cells of electrical rows formed by each bus bar and the battery cells coupled thereto are connected in parallel and the electrical rows are connected in series. In some embodiments, at least one of the battery cells of each linear row is not connected in parallel with other battery cells of the linear rows whereby the linear rows are not connected in series. In some embodiments, each bus bar is electrically coupled to battery cells in three linear rows. In some embodiments, each bus bar connects a number of battery cells that exceeds the number of battery cells in each of at least one of the linear rows. In some embodiments, the battery cells in a first linear row are positioned offset the battery cells in a second linear row adjacent to the first linear row.

### BRIEF DESCRIPTION OF THE DRAWINGS

Features of the invention can be better understood from the following detailed description when read in conjunction with the accompanying schematic drawings, which are for illustrative purposes only. The drawings include the following figures:

FIG. 1 is a sideview of a vehicle having a battery assembly;

FIG. 1A is a perspective view of the battery assembly of FIG. 1 comprising battery modules;

FIG. 2 is a perspective view of a battery module of FIG. 1A;

FIG. 2A is a perspective view of a portion of the battery module of FIG. 2 with an outer housing removed;

FIG. 2B is a top view of a portion of the battery module of FIG. 2 with the outer housing removed;

FIG. 2C is a top view of a portion of a top plate of the battery module of FIG. 2;

FIG. 3 is a top view of a portion of the battery module of FIG. 2 showing the electrical connections between individual battery cells;

FIG. 4 is a perspective view of a portion of the battery module of FIG. 2 illustrating the current flow;

FIGS. 5A-5B illustrate the positioning of a first battery module relative to a second battery module.

### DETAILED DESCRIPTION

While the present description sets forth specific details of various embodiments, it will be appreciated that the description is illustrative only and should not be construed in any way as limiting. Furthermore, various applications of such embodiments and modifications thereto, which may occur to those who are skilled in the art, are also encompassed by the general concepts described herein. Each and every feature described herein, and each and every combination of two or more of such features, is included within the scope of the present invention provided that the features included in such a combination are not mutually inconsistent.

This application discloses battery modules, in particular bus bars that facilitate electrical connection of battery cells within a battery module. While the term bus bar is primarily used herein, the bus bar(s) can also be referred to as a current collectors or battery interconnects. The battery modules can have physical rows of battery cells running along a length of the battery module and electrical rows of batteries that are defined by the shape and/or path of the bus bars. Electrical rows can correspond to a physical row in one or more segments or portions and can deviate from a physical row in one or more segments or portions. In some cases, adjacent bus bars can collect current from battery cells in a same or common physical row. In some cases, a bus bar can collect current from cells in three adjacent physical rows and can collect current from battery of a primary row and from battery cells in two adjacent rows. In some aspects, a bus bar can collect current from a first adjacent physical row shared with a first adjacent bus bar and from a second adjacent physical row shared with a second adjacent bus bar.

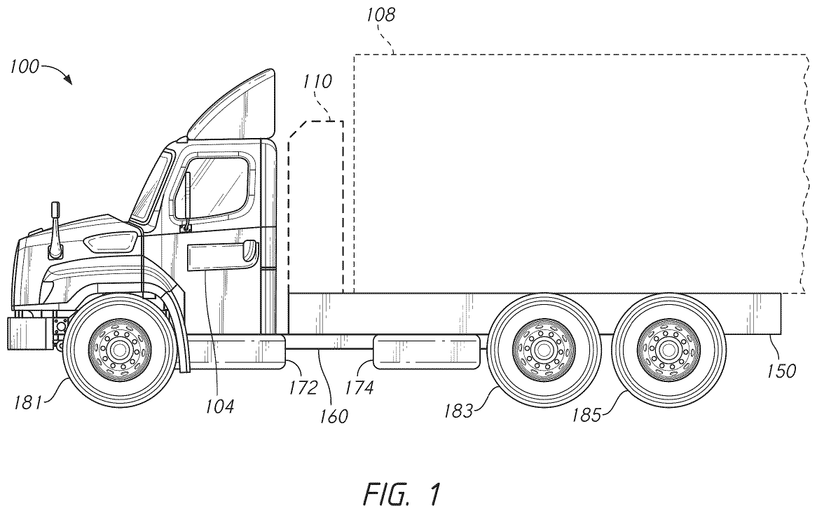

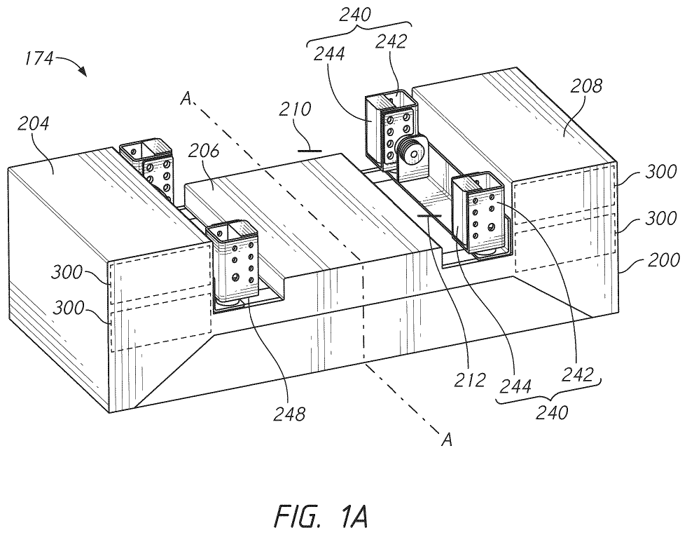

FIG. 1 illustrates a side view of a vehicle 100. The vehicle has a cab 104 and a vehicle frame for loading, supporting, securing, and/or towing cargo within a cargo enclosure 108. The vehicle 100 can have an electric drive system and at least one battery to power the electric drive system. The vehicle 100 can have a first battery assembly 172. The first battery assembly 172 can be positioned adjacent to or under the cab 104. The vehicle 100 can have a second battery assembly 174. The second battery assembly 174 can be located under a cargo frame 150 which can be a rearward portion of the vehicle frame. The cargo frame 150 can be a portion of the vehicle frame that is separable from the cab 10, e.g., as in a tractor-trailer arrangement. The cargo frame 150 can be permanently connected to a forward portion of the vehicle frame supporting the cab 104 as in a box truck. In certain embodiments, the vehicle has no battery to power its electric drive system under the cargo frame 150 and instead has one or more battery assemblies forward of the cargo area, e.g., under the cab 104.

In FIG. 1, the two battery assemblies 172, 174 can be coupled to a beam 160 that is fixed to or a part of the vehicle frame, e.g., of the cargo frame 150 and/or a frame assembly of the cab 104. The beam 160 is a structural member that bears the load of the cargo frame 150 and also supports other components directly or indirectly, such as the wheels and axles. The beam 160 can be referred to herein as a rail or frame rail. In some embodiments, a battery to power the vehicle's electric drive system is fixed to a frame of the cab 104. The second battery assembly 174 can be sized such that the second battery assembly 174 does not overlap the wheels 181, 183, 185 of the vehicle 100.

FIG. 1A is a perspective view of the battery assembly 174 according to an embodiment of the invention. The battery assembly 174 can include a housing 200 and at least one mounting system 240, 248 for coupling the battery assembly 174 to the beam 160. The housing 200 can comprise a first lateral portion 204, a second lateral portion 208, and a central portion 206 interposed between the lateral portions 204, 208. The central portion 206 does not extend as far in the vertical direction as the lateral portions 204, 208. A space 210 can be provided between the lateral portions 204, 208 to receive the beam 160. The space 210 can be disposed between an inward facing surface of the first lateral portion 204 and an inward facing surface of the second lateral portion 208. The inward facing surface can be surfaces that face toward a central vertical longitudinal plane of the vehicle 100 when the battery assembly 174 is mounted thereto. In other words, the inward surfaces can be closer to the central vertical longitudinal plane than are outward surfaces of the first and second lateral portions 204, 208 which face away from that central longitudinal plane.

At least one mounting system 240 can be provided in a recess 212 between the central portion 206 and the first lateral portion 204. The recess 212 can include a bight formed by the housing 200. The bight can be formed in a concave periphery on the top side of the housing 200. The bight can include a more complex shape such as two U-shaped or concave portions on opposite sides of a central vertical plan of the housing 200. The mounting system 240 can include a first member 242 fixed to a wall of the housing 200 (e.g., to a wall of the second lateral portion 208) that is facing the beam 160 and a second member or component 244 for connecting the first member 242 to the beam 160.

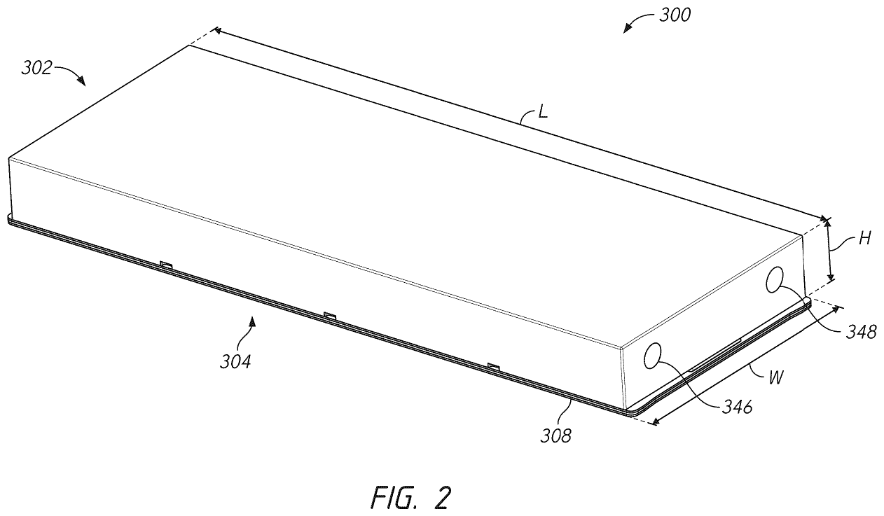

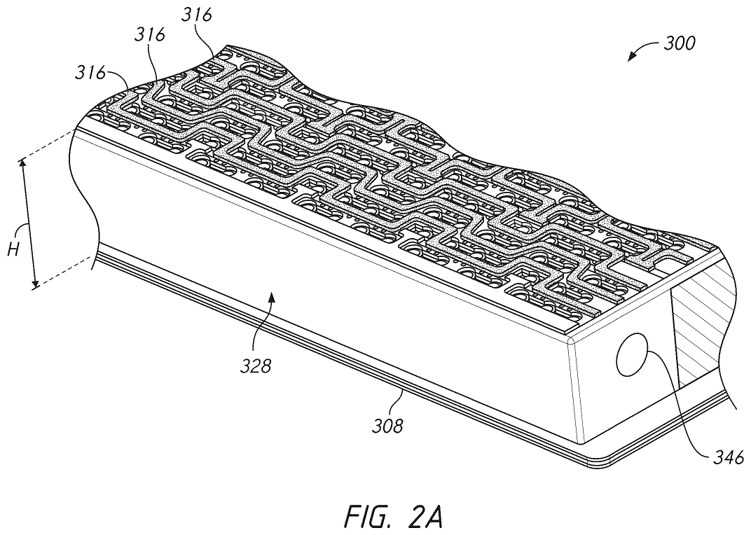

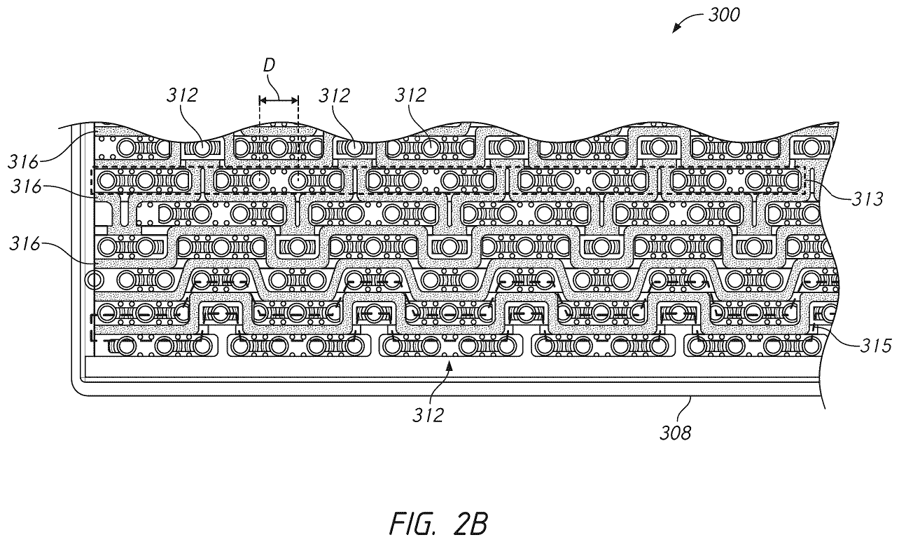

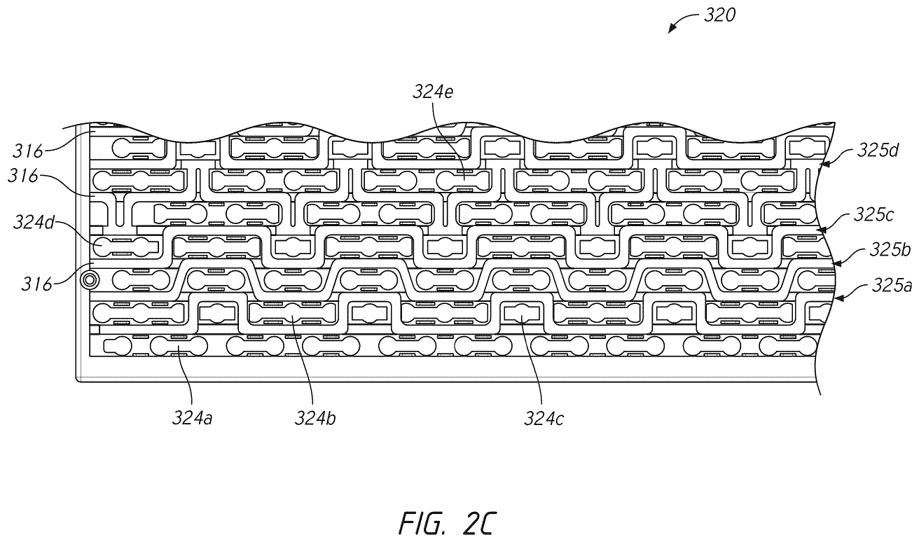

The battery assembly 174 can include one or more battery modules 300. The battery modules 300 can be positioned within the housing 200 in any one or more of the lateral portions 204, 208, or the central portion 206. For example, the first lateral portion 204 can have one, two, three, or more battery modules 300. In addition to the W-shaped configuration of FIG. 2, the battery assembly 174 can have a U-shaped configuration in which the central portion 206 does not protrude upwardly into the space 210. The battery assembly 174 can have a T-shaped configuration, including any of the configurations disclosed in U.S. 63/260,615, or a flat pack configuration as disclosed in U.S. 63/260,613, or a modular L-, T- or W-shaped configuration as disclosed in U.S. 63/260,610. The contents of each of the applications identified in the foregoing sentence is hereby incorporated by reference herein in their entireties such that these battery assembly configurations can enclose the battery module 300 discussed below.

While the battery module 300 is illustrated as being used in a battery assembly for a vehicle, the bus bars described herein can be used in battery modules used in any context where battery modules are used. For example, battery modules for passenger vehicles, battery modules for heavy-duty vehicles, battery modules for home energy storage, battery modules for storage of electricity generated by various systems and sources (e.g., solar, wind, water) may use the bus bars described herein.

FIG. 2 is a perspective view of the battery module 300. The battery module 300 can include an enclosure 302 configured to surround and/or protect the components therein. In some embodiments, the enclosure 302 is formed by an upper shell, which is referred to herein as a housing and can couple to a bottom plate 308 to enclose the components of the battery module 300. In some embodiments, the enclosure 302 is a single housing that surrounds the components of the battery module 300. The housing 304 can be configured to cover the top and sides of internal components of the battery module 300 disposed within the enclosure 302. The battery module 300 can have a length L and a width W. The length L can be longer than the width W. The battery module 300 can have a height H.

FIGS. 2A-2B are perspective and top views, respectively, of portions of the battery module 300 with the housing 304 removed. The battery module 300 can include a plurality of battery cells 312 and a plurality of bus bars 316. The battery cells 312 can be positioned on or adhered to the bottom plate 308 and extend vertically upward or away from the bottom plate 308. The battery cells 312 can be positioned in physical rows 313. An example physical row 313 is outlined by the dashed box. The physical rows 313 can extend in a lengthwise direction, e.g., along substantially the entire length L of the battery module 300, not including the thickness of or clearance between the housing 304 and the battery cells 312 and the ends of the physical row 313. The physical rows 313 can be parallel to the length L of the battery module 300. The physical rows 313 can be linear, e.g., a central vertical axis of each of the cells 312 on a physical row 313 can intersect an axis parallel to the length L or parallel to a plane intersecting the side surface of the housing 304. There can be any number of physical rows 313, and the exact number may depend on the context or application of the battery module 300. There can be any number of battery cells 312 within a physical row 313. Each physical row 313 can have the same number of battery cells 312. In some variations, there are different numbers of battery cells 312 in some of the physical rows 313. Alternating physical rows 313 of battery cells 312 can have the same number of battery cells 312. Adjacent physical rows 313 of battery cells 312 can have the same number or different number of battery cells 312.

The battery cells 312 positioned in a physical row 313 can be separated a distance D, as shown in FIG. 2B. A first row of battery cells 312 can be positioned offset from a second row of battery cells 312. For example, a battery cell 312 in the second row can align with the spacing created by the distance D rather than being directly next to a battery cell 312 from the first row. The battery cells 312 can create a nested pattern.

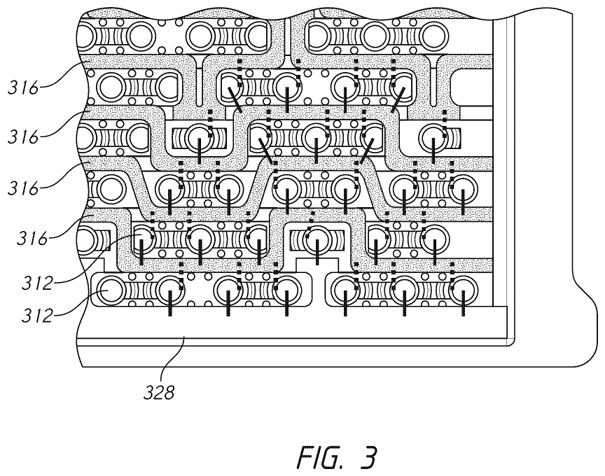

The bus bars 316 can extend along a top plate (or “cell holder”) 320, shown in FIG. 2C, along the length L of the battery module 300. The top plate 320 can otherwise be referred to as a cell holder, cell carrier, cell tray, cell separator, or cell locator. The top plate 320 is an example of a component disposed within the enclosure 302. The top plate 320 can be positioned within the housing 304, e.g., between the top of the battery cells 312 and an inward facing surface of the shell or housing 304. The top plate 320 may include features (e.g., protrusions) to facilitate maintaining of the relative spacing of the battery cells 312. The top plate 320 is also made of a non-conductive material to insulate the battery cells 312 from the bus bars 316. The bus bars 316 can sit or be disposed on and/or rest in a corresponding channel of the top plate 320. The bus bars 316 can be flush with a top surface of the top plate 320. The bus bars 316 can be flat or planar on a top side, a bottom side or both a top and bottom side thereof. The bus bars 316 can have a substantially uniform thickness, e.g., not varying more than 20 percent and in some cases not more than 10 percent in thickness across the length thereof. The bus bars 316 can be wire bonded to the battery cells 312, as discussed in more detail below with reference to FIG. 3. The bus bars 316 can be bonded using ultrasonic bonding or another suitable method.

The bus bars 316 can separate the battery cells 312 into electrical rows 315, discussed in more detail below and shown in FIG. 2B. The shape of the bus bars 316 can define the electrical rows 315. Portions of the electrical rows 315 can be U-shaped. Portions of the electrical rows 315 can be non-linear. The electrical rows 315 extend in a horizontal plane and portions of the electrical rows 315 can extend in length-wise directions, transverse to the length-wise direction (width-wise directions), and/or at angles relative to the length-wise and width-wise directions. The electrical rows 315 may have different shapes. For example, a first electrical row 315 can have a different shape from a second electrical row 315, and the first electrical row can include a different number of battery cells 312 and/or connect a different number of physical rows 313 as compared to the second electrical row. As such the number of physical rows 313 connected by each electrical row 315 can be different. The electrical rows 315 can extend and/or connect more than one physical row 313 of battery cells 312. The bus bars 316 can be electrically coupled to battery cells 312. For example, a first bus bar 316 can connect battery cells 312 from two physical rows 313, and a second bus bar 316 can connect battery cells 312 from three physical rows 313.

The bus bars 316 can connect any number of battery cells 312. In some embodiments, a single bus bar 316 can connect more battery cells 312 than the number of battery cells 312 in a single physical row 313. The bus bars 316 can connect battery cells 312 from two physical rows 313, as described in more detail below. The bus bars 316 can connect battery cells 312 from three physical rows 313, as described in more detail below. The bus bars 316 can connect battery cells 312 from more than three physical rows 313. The appearance and/or pattern of the bus bars 316 can be determined based on the battery cells 312 being connected. For example, portions of the bus bars 316 can extend length-wise, width-wise, and angled directions in a horizontal plane to be positioned in a location to be able to connect to the necessary battery cells 312, as described in more detail below.

The battery module 300 can have electrical connectors. A first electrical connector 328 can electrically connect a first terminal 346 to the bus bars 316. A second electrical connector 336 can electrically connect the bus bars 316 to a second terminal 348. The first terminal 346 and the second terminal 348 are used to couple the battery module 300 to other battery modules and/or other vehicle systems. As will be described herein, the first terminal 346 and the second terminal 348 may be configured to have different polarities, depending on the configuration of the wire bonds used to couple the battery cells to the bus bars. That is, in some embodiments, the first terminal 346 is a positive terminal and the second terminal 348 is a negative terminal, and in other embodiments, the first terminal 346 is a negative terminal and the second terminal 348 is a positive terminal.

The first electrical connector 328 and the second electrical connector 336 can be positioned along first and second sides of the battery module 300, extending along the length L of the battery module 300 and opposite each other. In some embodiments, the first electrical connector 328 and the second electrical connector 336 have an L shape, wrapping around a portion of the length of the battery module and a portion of the width of the battery module. In some embodiments, the first electrical connector 328 and the second electrical connector 336 have a straight shape along the length of the battery module, and the terminals 346 and 348 are located along the length of the battery module. The first electrical connector 328 and the second electrical connector 336 may each be made of a single piece of conductive material or may be made of a plurality of pieces of conductive material coupled together. The first electrical connector 328 and the second electrical connector 336 can span a portion of the height H of the battery module 300 and connect to the bus bars 316 at multiple discrete locations or continuously along a length of the outermost bus bars 316. The first electrical connector 328 and the second electrical connector 336 may have features, shapes, or dimensions that promote distribution of current along the length of the module.

A cooling system may be used to regulate the temperature of the battery cells 312 of the battery module 300. In some embodiments, a cooling fluid or substance is located between the battery cells 312 within the battery module 300. In some embodiments, cooling tubes are disposed between the battery cells 312 and a fluid is circulated within the cooling tubes to absorb heat from the battery cells 312. In some embodiments, a cooling plate is used to facilitate cooling of the battery cells 312. The cooling system can provide for uniform cooling across the battery module 300.

FIG. 2C is a top view of a portion of the top plate 320. The top plate 320 has been removed from the battery module 300 in FIG. 2C. The top plate 320 can be configured to sit on top of the battery cells 312. The top plate 320 has a plurality of openings 324. The plurality of openings can expose the tops of the battery cells 312. The plurality of openings 324 can be elongate openings extending parallel to the length L of the battery module 300. The plurality of openings 324 can extend across any number of battery cells 312. For example, one, two, three or more battery cells 312.

The plurality of openings 324 can have a variety of shapes. The shape of the openings 324 can be dependent upon the positioning of the battery cells 312 and the bus bars 316. The plurality of openings 324 can be sized and shaped to expose both negative and positive connection points or terminals on each battery cell 312. Some openings 324a can define an area having generally circular ends connected by an elongate, e.g., a generally rectangular portion. Some openings 324b can have a generally circular center connected by an elongate, e.g., a generally rectangular portions to ends having generally half-circular shapes. Some openings 324c can have a generally circular center with elongate, e.g., generally rectangular, ends. Some openings 324d can have one generally circular end, a generally circular center and a generally half-circular end connected by elongate, e.g., generally rectangular portions. Some openings 324e can have one generally circular end connected to a generally semi-circular end. Any combination of circular, half-circular, and elongate, e.g., rectangular opening 324 is possible. The half-circular openings allow a bus bar to be located over a battery cell while still allowing for access to the positive and negative terminals of the partially-covered battery cell. The partially-covered battery cell is electrically insulated and separated from the bus bar disposed above it.

The design and shape of the bus bars 316 can determine the size and shapes of the openings 324. For example, using the orientation of FIG. 2C for purposes of explanation, a first bus bar 325a from left to right can extend along the length L three battery cells, extend along the width W one physical row, extend along the length L one battery cell, extend along the width W one battery cell, and then repeat that path until it reaches the opposite end of the top plate 320. Depending on the length L, the repeating pattern may end in a configuration that does not perfectly repeat due to spacing. For example, the repeating pattern may end with an extension along the length L of one, two, or three battery cells. This is applicable to all repeating paths described herein. The first bus bar 325a couples battery cells in two physical rows 313. A second bus bar 325b, from left to right, can extend along the length L two battery cells, extend along the width W at an angle one physical row extend along the length L two battery cells, extend along the width W at an angle one physical row, and then repeat that path until it reaches the opposite end of the top plate 320. The second bus bar 325b couples battery cells in two physical rows 313. A third bus bar 325c, from left to right, can extend an initial two battery cells along the length L, along the width W one physical row, along the length L three battery cells, along the width W one physical row, and the repeat the along the width W one physical row, along the length L three battery cells, along the width W one physical row. The third bus bar 325c couples battery cells in two physical rows 313. A fourth bus bar 325d, from left to right, can extend along the length L three battery cells, with a width-wise portion extending up and down one physical row, along the width W upward and downward one physical row, along the length L four battery cells with a width-wise portion extending up and down one physical row, and then repeat the along the width W upward and downward one physical row, along the length L four battery cells with a width-wise portion extending up and down one physical row. The fourth bus bar 325d couples battery cells in three physical rows 313. The portions of the bus bars 325a-d that extend at angles can be angled at angles greater than 0 degrees and less than 90 degrees relative to the length L or width W. For example, the angles can be about 15 degrees, about 30 degrees, about 45 degrees, about 60 degrees, and about 75 degrees. Angled portions of the bus bars 325a-d can be used to maximize the distance between adjoining bus bars that are at right angles. The angled portions can be used in some embodiments to reduce length and ensure adequate clearance to the battery cells. For example, it can be beneficial to keep the bus bars a minimum distance away from the battery cells. The bus bars 325a-d, described herein are representative of example shapes of bus bars. Any number of bus bar shapes can be defined and in any order using an of the example bus bar shapes or other bus bar shape patterns.

FIG. 3 is a top view of a portion the battery module of 300 illustrating example electrical connections between individual battery cells 312. Except for the connections described herein, the battery cells 312 are otherwise uncoupled or insulated from each other. The bus bars 316 can be wire bonded to the battery cells 312. The battery cells 312 can also be wire bonded to the electrical connectors 328 (e.g., the battery cells 312 along the lengthwise edges of the battery module 300 can be wire bonded to the electrical connectors 328). The solid lines represent electrical connections to the positive terminals of the battery cells 312. The dashed lines represent electrical connections to the negative terminals of the battery cells 312. Each battery cell 312 can have a positive and negative wire bonded connection. Each battery cell 312 can be wire bonded to a first and a second bus bar 316 or to a bus bar 316 and the electrical connector 328. The wires used for the bonding can be bare wire or insulated wire components.

While the configuration of FIG. 3 shows the positive terminals of the battery cells 312 coupled to the bus bar 316 lower on the page and the negative terminals of the battery cells 312 coupled to the bus bar 316 higher on the page, wires and wire bonds can be configured such that the connections of the positive and negative terminals are reversed. For example, in some embodiments the positive terminals of the battery cells 312 can be coupled to the bus bar 316 higher on the page and the negative terminals of the battery cells 312 coupled to the bus bar 316 lower on the page. This can provide flexibility when positioning battery modules within a battery assembly, e.g., the battery assembly 174.

The battery cells 312 of each electrical row 315 can be connected in parallel. The electrical rows 315 can be connected in series. The battery cells 312 of each physical row 313 are not connected in parallel due to the winding shape of the bus bars. The physical rows 313 are not connected in series.

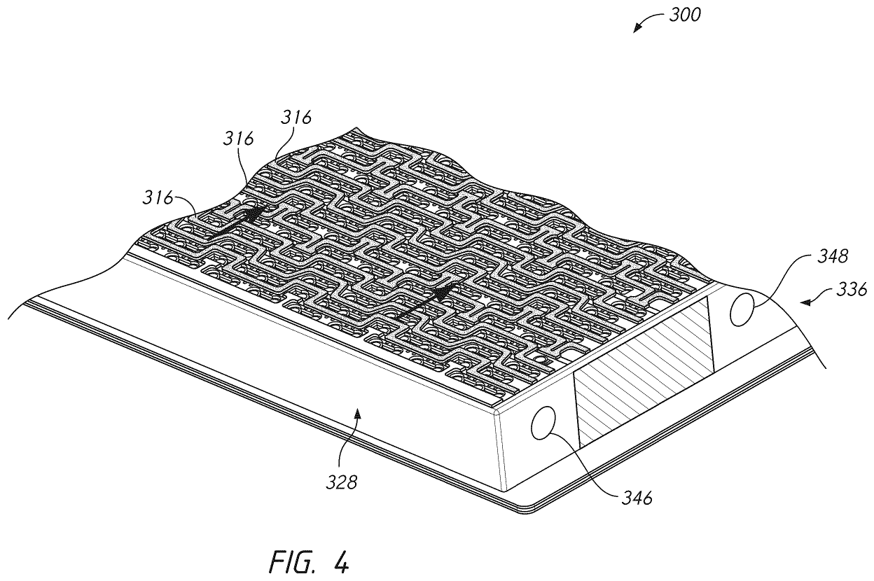

FIG. 4 is a perspective view of a portion of the battery module 300 illustrating the current flow. The current can flow from the first terminal 346 to the first electrical connector 328. The current can flow across the battery cells and the bus bars 316. The current can flow across the width W of the battery module 300. The wire bonds between the battery cells 312 and bus bars 316 can facilitate the current flow. The current can flow from the bus bars 316 to the second electrical connector 336 and to the second terminal 348.

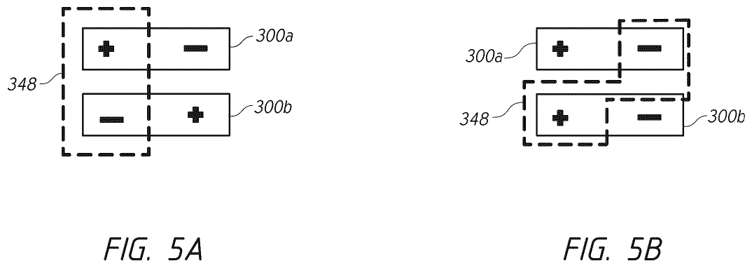

FIGS. 5A and 5B schematically represent the benefit of the battery modules 300 having selectable or reversible polarity. For example, FIG. 5A is illustrative of two battery modules 300a and 300b. The first battery module 300a has a positive terminal on the left side (e.g., first terminal 346) and a negative terminal on the right side (e.g., second terminal 348). The second battery module 300b has a negative terminal on the left side (e.g., first terminal 346) and a positive terminal on the right side (e.g., second terminal 348). The structure and orientation of the first battery module 300a and the second battery module 300b are similar, except for the configuration of wire bonding resulting in the respective first terminal and second terminal having different polarities, as described herein. In this regard, battery modules 300a and 300b can be referred to as having opposite polarities. The opposite polarities allow for an electrical connection 348 between the battery modules to be shorter. In contrast, the electrical connection 348 in FIG. 5B is much longer. This is because the positive and negative terminals are located on the same widthwise ends. As such, the electrical connection 348 needs to travel from the right side of battery module 300a to the left side of battery module 300b. The ability to have short electrical connections can reduce resistance losses, the weight of the battery assemblies and the overall cost of each module and of battery assembly 174 comprising several modules. The shorter electrical connections can also increase safety. With reference to FIG. 1A, the battery modules 300 in the first and second lateral portions 204, 208 can have alternating polarity, such that adjacent battery modules 300 can be connected using shorter electrical connections.

While certain embodiments of the inventions have been described, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure. Accordingly, the scope of the present inventions is defined only by reference to the appended claims.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, or 0.1 degree.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

What is claimed is:

1. A battery module having a width and a length, the battery module comprising:
a plurality of battery cells arranged in a plurality of physical rows along the length of the battery module; and
a plurality of bus bars located along the length of the battery module and defining a plurality of electrical rows of battery cells,
wherein each bus bar is electrically coupled to battery cells of more than one of the plurality of physical rows, and
wherein the battery cells of each electrical row are connected in parallel and the electrical rows are connected in series.

2. The battery module of claim 1, wherein at least one of the battery cells of each physical row is not connected in parallel with an adjacent battery cell in the physical row.

3. The battery module of claim 1, wherein each bus bar is electrically coupled to battery cells in three physical rows.

4. The battery module of claim 1, wherein each bus bar of the plurality of bus bars connects a number of battery cells that exceeds the number of battery cells in one of the physical rows.

5. The battery module of claim 1, wherein the battery cells in a first physical row are positioned offset the battery cells in a second physical row adjacent to the first physical row.

6. The battery module of claim 1, further comprising a top plate positioned on top of the plurality of battery cells, the top plate comprising a plurality of openings configured to expose a positive terminal and a negative terminal of each battery cell.

7. A battery module comprising:
a plurality of battery cells arranged in a plurality of linear rows, a first end of each of the plurality of battery cells coupled to a bottom plate; and
a plurality of bus bars coupled to a top plate, the top plate positioned above a second end of each of the plurality of battery cells, the top plate comprising a plurality of openings configured to expose a positive terminal and a negative terminal of each battery cell, at least one bus bar of the plurality of bus bars having a non-linear shape whereby a first portion of the at least one bus bar is coupled with one or more battery cells in a select linear row of the plurality of linear rows and a second portion of the at least one bus bar is coupled with one or more cells not in the select linear row of the plurality of linear rows.

8. The battery module of claim 7, wherein the battery cells of electrical rows formed by each bus bar and the battery cells coupled thereto are connected in parallel and the electrical rows are connected in series.

9. The battery module of claim 7, wherein at least one of the battery cells of each linear row is not connected in parallel with other battery cells of the linear rows whereby the linear rows are not connected in series.

10. The battery module of claim 7, wherein each bus bar is electrically coupled to battery cells in three linear rows.

11. The battery module of claim 7, wherein each bus bars connects a number of battery cells that exceeds the number of battery cells in each of at least one of the linear rows.

12. The battery module of claim 7, wherein the battery cells in a first linear row are positioned offset the battery cells in a second linear row adjacent to the first linear row.

13. A battery assembly comprising:
a housing; and
a battery module enclosed by the housing, wherein the battery module comprises:
a plurality of battery cells positioned in a plurality of physical rows;
a plurality of bus bars, each bus bar of the plurality of bus bars coupled to a subset of battery cells of the plurality of battery cells disposed in more than one physical row, the bus bar and the subset of battery cells coupled thereto forming electrical rows of the battery module; and
wherein the battery cells of each electrical row are connected in parallel and the electrical rows are connected in series.

14. The battery assembly of claim 13, wherein the battery module is a first battery module and further comprising a second battery module, the first battery module and the second battery module configured to have opposite polarities.

15. The battery assembly of claim 13, wherein the battery assembly is coupled to a vehicle.

16. The battery assembly of claim 13, wherein at least one of the battery cells of each physical row is not connected in parallel with an adjacent battery cell of the physical row.

17. The battery assembly of claim 13, wherein each bus bar is electrically coupled to battery cells in three physical rows.

18. The battery assembly of claim 13, further comprising a top plate positioned on top of the plurality of battery cells, the top plate comprising a plurality of openings configured to expose a positive and a negative terminal of each battery cell of the plurality of battery cells.
